(19) United States
(12) Patent Application Publication
(10) Pub. No.: US 2022/0089157 A1
(43) Pub. Date: Mar. 24, 2022

(54) Vehicle Control Apparatus, Vehicle Control Method, and Vehicle Following Running System

(71) Applicant: Hitachi Astemo, Ltd., Hitachinaka-shi, Ibaraki (JP)

(72) Inventors: Hiroshi ITO, Hitachinaka-shi, Ibaraki (JP); Kentaro UENO, Hitachinaka-shi, Ibaraki (JP); Tatsuya IBA, Hitachinaka-shi, Ibaraki (JP)

(21) Appl. No.: 17/298,208

(22) PCT Filed: Nov. 22, 2019
(86) PCT No.: PCT/JP2019/045763

§ 371 Date: May 28, 2021

(30) Foreign Application Priority Data
Nov. 29, 2018 (JP) 2018-223105

(51) Int. Cl. B60W 30/165; B60W 10/18; B60W 10/20; B60W 10/04

(52) U.S. Cl. CPC B60W 30/165; B60W 10/18; B60W 2710/20; B60W 10/04; B60W 2710/18; B60W 10/20

(57) ABSTRACT

A vehicle control apparatus, a vehicle control method, and a vehicle following running system according to the present invention are configured in the following manner. In a vehicle following running system, a first vehicle, a second vehicle subsequent to the first vehicle, and the third vehicle subsequent to the second vehicle carry out following running by being non-mechanically connected. The third vehicle selectively acquires first vehicle information including a first physical amount regarding a motion of the first vehicle and second vehicle information including a second physical amount regarding a motion of the second vehicle.

### TECHNICAL FIELD

The present invention relates to a vehicle control apparatus, a vehicle control method, and a vehicle following running system applicable to following running based on a non-mechanical connection.

### BACKGROUND ART

When receiving data from a preceding vehicle, a platoon running control apparatus discussed in PTL 1 assigns an identification number acquired by converting an identification number of the preceding vehicle according to a predetermined rule to an own vehicle on which this control apparatus is mounted, and controls running of this own vehicle according to the assigned identification number.

According to a vehicle running control apparatus discussed in PTL 2, a lead vehicle determines what number vehicle each vehicle is from the head based on the number of vehicles in a vehicle group, and provides the determined information by multi-destination transmission.

### CITATION LIST

### Patent Literature

PTL 1: Japanese Patent Application Public Disclosure No. 9-081899
PTL 2: Japanese Patent Application Public Disclosure No. 2011-170555

### SUMMARY OF INVENTION

### Technical Problem

Then, in a case of a following running system configured in such a manner that a preceding vehicle repeats the transmission of vehicle information including, for example, the braking/driving and steering state of this preceding vehicle to a following vehicle immediately subsequent thereto and each of a plurality of following vehicles carries out the following running based on the vehicle information of the immediately preceding vehicle, a delay in the running control may be accumulated and control instability may be amplified for a vehicle located at a farther back position.

On the other hand, in a case of a system configured in such a manner that a lead vehicle transmits the vehicle information of the lead vehicle toward a plurality of following vehicles by multi-destination communication and each of the plurality of following vehicles carries out the following running based on the vehicle information of the lead vehicle, received electric power (i.e., a received signal strength) from the lead vehicle reduces for a following vehicle located farther distance away from the lead vehicle. Then, the reduction in the received electric power may cause control instability and communication instability due to an increase in a delay in the information transmission and a failure in the communication.

In other words, in any of these following running system cases, control instability and communication instability may occur when the platoon is extended according to an increase in the number of connected vehicles.

### Solution to Problem

An object of the present invention is to provide a vehicle control apparatus, a vehicle control method, and a vehicle following running system capable of preventing control instability and communication instability even when a platoon is extended according to an increase in the number of connected vehicles in following running based on a non-mechanical connection.

According to one aspect of the present invention, in a vehicle following running system, a first vehicle, a second vehicle subsequent to the first vehicle, and the third vehicle subsequent to the second vehicle carry out following running by being non-mechanically connected. The third vehicle selectively acquires first vehicle information including a first physical amount regarding a motion of the first vehicle and second vehicle information including a second physical amount regarding a motion of the second vehicle.

### Advantageous Effects of Invention

According to the one aspect of the present invention, the control instability and the communication instability can be prevented even when the platoon is extended according to an increase in the number of connected vehicles in the following running based on the non-mechanical connection.

### BRIEF DESCRIPTION OF DRAWINGS

FIG. 1 is a functional block diagram of a lead vehicle and a following vehicle.

FIG. 2 illustrates how inter-vehicle communication is carried out in a platoon.

FIG. 3 is a functional block diagram of processing for selecting vehicle information based on received electric power.

FIG. 4 is a flowchart illustrating a procedure of the processing for selecting the vehicle information based on the received electric power.

FIG. 5 is a functional block diagram of processing for selecting the vehicle information based on a communication link.

FIG. 6 is a flowchart illustrating a procedure of the processing for selecting the vehicle information based on the communication link.

FIG. 7 is a functional block diagram of processing for selecting the vehicle information based on a communication delay time.

FIG. 8 is a flowchart illustrating a procedure of the processing for selecting the vehicle information based on the communication delay time.

FIG. 9 illustrates switching of a source to acquire the vehicle information based on a communication state.

FIG. 10 is a functional block diagram of processing for selecting the vehicle information based on a comparison of vehicle specification information.

FIG. 11 is a flowchart illustrating a procedure of the processing for selecting the vehicle information based on the comparison of the vehicle specification information.

### DESCRIPTION OF EMBODIMENTS

In the following description, embodiments of a vehicle control apparatus, a vehicle control method, and a vehicle control system according to the present invention will be described with reference to the drawings.

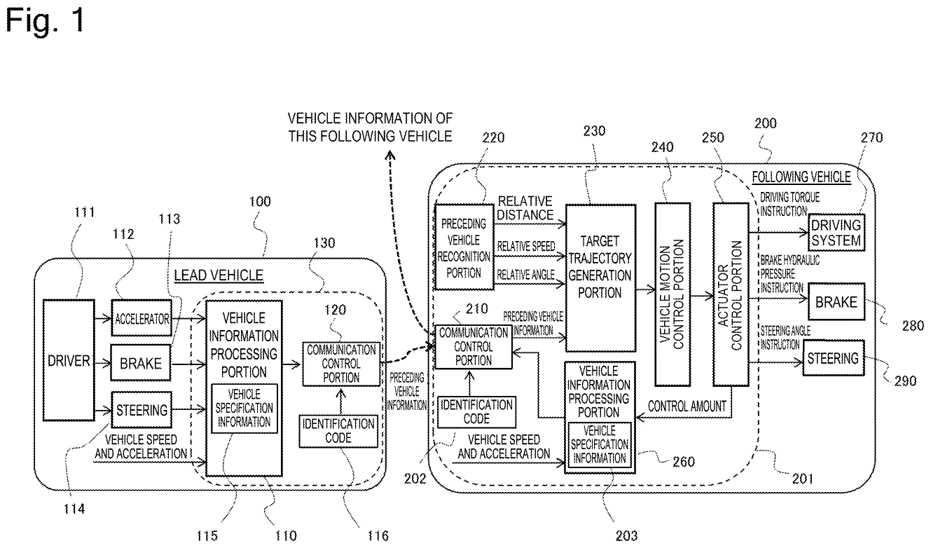

FIG. 1 is a functional block diagram of a lead vehicle 100 and a following vehicle 200 forming a platoon in following running based on a non-mechanical connection (i.e., platoon running based on an electric connection).

The following vehicle 200 refers to a vehicle running at the second or later position from the head among a plurality of vehicles forming the platoon, and all the following vehicles 200 include functional blocks illustrated in FIG. 1.

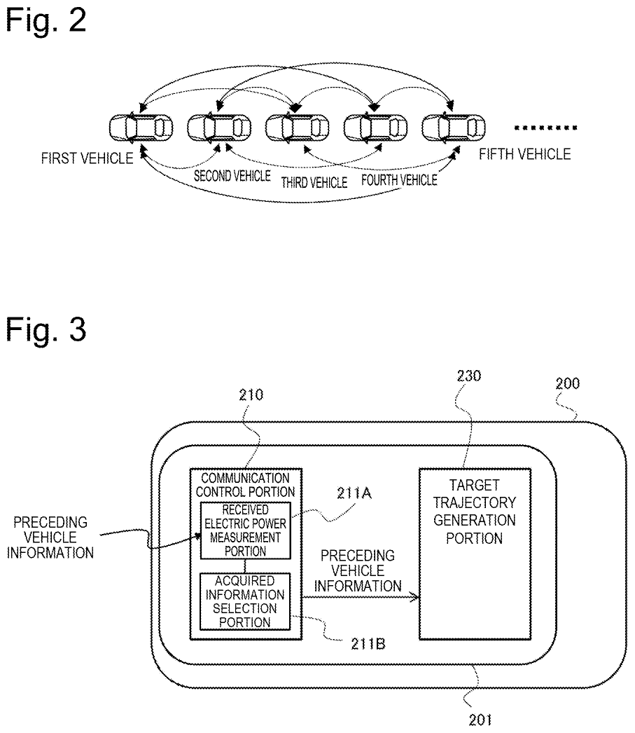

FIG. 2 exemplarily illustrates how the following running is carried out, and a first vehicle, a second vehicle, a third vehicle, a fourth vehicle, and a fifth vehicle, which are the vehicles running at the first, second, third, fourth, and fifth positions, respectively, form the platoon by being lined up in this order from the head.

Now, the first vehicle in FIG. 2 is the lead vehicle 100 driven and operated by a driver.

Further, the second vehicle and the vehicles subsequent thereto, i.e., the vehicles running at the second and later positions in FIG. 2 are each the following vehicle 200.

The following vehicle 200 is equipped with a vehicle control apparatus that performs following running control.

The vehicle control apparatus of the following vehicle 200 receives vehicle information including a physical amount regarding a motion of a preceding vehicle from the preceding vehicle via wireless communication between the vehicles, calculates a control operation amount of this following vehicle 200 so as to run while following the preceding vehicle based on the received vehicle information of the preceding vehicle (i.e., preceding vehicle information) and the situation of this following vehicle 200, and outputs an instruction based on the calculated control operation amount to, for example, a braking/driving apparatus and a steering apparatus of this following vehicle 200, thereby controlling braking/driving and steering of this following vehicle 200.

The physical amount regarding the motion of the preceding vehicle includes a control operation amount such as the braking/driving and the steering of the preceding vehicle and a running state amount such as the vehicle speed and the acceleration of the preceding vehicle.

The lead vehicle 100 includes a vehicle control apparatus 130 including a vehicle information processing portion 110 and a communication control portion 120.

The vehicle information processing portion 110 (a motion state acquisition portion) processes the vehicle information of the lead vehicle 100 including the control operation amount, which is an operation amount input by a driver 111 regarding each of an accelerator pedal 112, a brake pedal 113, and a steering wheel 114, the running state amount such as the vehicle speed and the acceleration of the lead vehicle 100, vehicle specification information 115 of the lead vehicle 100, and the like.

The vehicle specification information 115 includes information such as the vehicle dimension (the width, the height, and the length), the vehicle weight, and the total emission of the engine.

The communication control portion 120 combines the vehicle information of the lead vehicle 100 that is processed by the vehicle information processing portion 110 and an identification code 116 such as an identification number for identifying the lead vehicle 100, and transmits them to the following vehicle 200 as the preceding vehicle information via the wireless communication.

Now, the lead vehicle 100 is configured wirelessly communicably with all of the following vehicles 200 (refer to FIG. 2).

The following vehicle 200 includes a vehicle control apparatus 201 including a communication control portion 210, a preceding vehicle recognition portion 220, a target trajectory generation portion 230, a vehicle motion control portion 240, an actuator control portion 250, and a vehicle information processing portion 260 (a motion state acquisition portion).

Then, the preceding vehicle recognition portion 220, the target trajectory generation portion 230, the vehicle motion control portion 240, and the actuator control portion 250 form a control unit that selectively acquires the vehicle information of the preceding vehicle, determines a physical amount regarding a motion of this following vehicle 200 based on the selected vehicle information, and outputs the instruction to the braking/driving apparatus and the steering apparatus based on the determined physical amount.

Each of the functional blocks of the lead vehicle 100 and the following vehicle 200 illustrated in FIG. 1 is realized by execution of software by a microcomputer (CPU) included in the vehicle control apparatus 130 or 201, or a combination of execution of software by the microcomputer (CPU) and a hardware member.

The communication control portion 210 receives the vehicle information transmitted from the preceding vehicle and the identification code of this preceding vehicle via the wireless communication between the vehicles.

The preceding vehicle recognition portion 220 recognizes the preceding vehicle with use of a radar or a camera, and acquires preceding vehicle recognition information such as the relative distance, the relative speed, and the relative angle to the preceding vehicle.

The target trajectory generation portion 230 generates information regarding a target trajectory of this following vehicle 200 for following the running trajectory of the preceding vehicle based on the vehicle information of the preceding vehicle received by the communication control portion 210, the preceding vehicle recognition information acquired by the preceding vehicle recognition portion 220, and the like.

The vehicle motion control portion 240 acquires information regarding the target trajectory generated by the target trajectory generation portion 230, and calculates a control instruction for the vehicle motion (the braking/driving and the steering) regarding this following vehicle 200 so as to cause this following vehicle 200 to run while following the target trajectory.

The actuator control portion 250 calculates a driving torque instruction, a brake hydraulic pressure instruction, and a steering angle instruction regarding the braking/driving and the steering of this following vehicle 200 based on the control instruction (a third physical amount) of the vehicle motion control portion 240.

Then, the actuator control portion 250 outputs the driving torque instruction to a driving apparatus 270, outputs the brake hydraulic pressure instruction to a brake apparatus 280, and outputs the steering angle instruction to a steering apparatus 290, thereby controlling the braking/driving and the steering of this following vehicle 200.

The driving apparatus 270 and the brake apparatus 280 correspond to the braking/driving apparatus.

Further, the vehicle information processing portion 260 processes vehicle information including each of the control operation amounts of the driving torque instruction, the brake hydraulic pressure instruction, and the steering angle instruction issued by the actuator control portion 250, the running state amount such as the vehicle speed and the acceleration of this following vehicle 200, vehicle specification information 203 of this following vehicle 200, and the like. In other words, the vehicle information processing portion 260 processes the vehicle information including the control operation amount, the physical amount regarding the motion of this following vehicle 200 such as the running state amount, the vehicle specification information 203 of this following vehicle 200, and the like.

Then, the communication control portion 210 combines the vehicle information of this following vehicle 200 that is processed by the vehicle information processing portion 260 and an identification code 202 for identifying this following vehicle 200, and transmits them as the vehicle information wirelessly.

Now, the communication control portion 210 of the following vehicle 200 has a function of, when there is a plurality of preceding vehicles, selecting the preceding vehicle to acquire the vehicle information, i.e., a function of selectively acquiring the vehicle information from a plurality of pieces of vehicle information transmitted from the plurality of preceding vehicles.

The following vehicle 200 running at the second position immediately behind the lead vehicle 100 has only the lead vehicle 100 as the preceding vehicle thereto, and carries out the following running based on the vehicle information of the lead vehicle 100 (lead vehicle information)

On the other hand, the following vehicle 200 running at the third or later position has two or more vehicles as the preceding vehicle thereto, and therefore performs processing for selecting the preceding vehicle to acquire the vehicle information.

For example, the following vehicle 200 running at the third position is configured to be able to be switched to a state of acquiring the vehicle information from the lead vehicle 100 (first vehicle information including a first physical amount regarding a motion of a first vehicle) and a state of acquiring the vehicle information from the preceding vehicle running at the second position, i.e., the preceding vehicle running immediately ahead of this third following vehicle 200 (second vehicle information including a second physical amount regarding a motion of a second vehicle).

The communication control portion 210 of the following vehicle 200 can arbitrarily determine which preceding vehicle is targeted for the acquisition of the vehicle information among the plurality of preceding vehicles within a range that stabilizes the control or a range that stabilizes the communication, and, further, can also select it by setting a selection condition such as providing a method for detecting and monitoring the state of the wireless communication and automatically switching it according to the state of the wireless communication.

The communication control portion 210 of the following vehicle 200 determines what number running position in the platoon is held by the preceding vehicle that transmits the vehicle information based on the identification code transmitted together with the vehicle information.

Further, the communication control portion 210 of the following vehicle 200 can have a vehicle information relay function of relaying the vehicle information and the identification code received from another vehicle to transmit them to further another vehicle.

Further, for example, the communication control portion 210 of the following vehicle 200 can also have a function of directly relaying the received vehicle information of the preceding vehicle to transfer it to another following vehicle 200 without handling it as following running control information for this following vehicle 200.

Information specific to the vehicle included in CAN (Controller Area Network) information can be used as the identification code of the vehicle. Alternatively, a MAC address (a physical address) specific to the communication device of the communication control portion 120 or 210 or an IP address individually set to the communication control portion 120 or 210 can be used as the identification information.

Further, the identification code of the vehicle can include information about a predetermined running order.

For example, the communication control portion 120 or 210 can recognize the number of vehicles by which the preceding vehicle transmitting the vehicle information is running ahead of this following vehicle 200, and, similarly, can recognize the number of vehicles by which the following vehicle transmitting the vehicle information is running behind this following vehicle 200, by saving the information about the running order as an internal table and referring to this information about the running order.

Further, the communication control portion 120 or 210 can be configured in such a manner that the information about the running order held by the communication control portion 120 or 210 can be overwritten from outside via communication. For example, the communication control portion 120 or 210 can be configured in such a manner that running order information from a driving control system or the like is transmitted from a roadside unit to this vehicle via a network infrastructure by road-to-vehicle communication, and the information about the running order such as a running order table held by the communication control portion 120 or 210 is overwritten with the received information.

In this case, an arbitrarily vehicle that receives the running order information from the driving management system, such as the lead vehicle 100, can transmit an instruction to overwrite the running order information to all the following vehicles 200 as driving control of the platoon vehicle group.

FIG. 2 illustrates how the vehicle information is communicated wirelessly between vehicles (inter-vehicle communication) in the platoon that carries out the following running based on the non-mechanical connection.

FIG. 2 illustrates that the first vehicle serves as the lead vehicle, and the first vehicle, the second vehicle, the third vehicle, the fourth vehicle, and the fifth vehicle engage in the following running while forming the platoon in this running order.

In the following running based on the non-mechanical connection, the following vehicle 200 acquires the vehicle information including the control operation amount such as the braking/driving state and the steering state of the preceding vehicle, and automatically controls the following running based on the acquired vehicle information. Now, the following vehicle 200 selectively acquires the vehicle states of the plurality of preceding vehicles.

For example, referring to FIG. 2, the following vehicle 200 as the third or later vehicle selectively acquires the vehicle information from the plurality of preceding vehicles and performs the following running control based on the acquired vehicle information as described above.

Selectively acquiring the vehicle information includes selecting the preceding vehicle to receive the information used in the following running of this following vehicle 200, and acquiring each of the pieces of vehicle information of the plurality of preceding vehicles and selecting the vehicle information used in the following running control of this following vehicle 200 from this plurality of pieces of vehicle information.

The details of the selective acquisition of the vehicle information will be described in detail below.

Further, each of the vehicles forming the platoon can relay the vehicle information of the acquired preceding vehicle to transfer it to the following vehicle subsequent thereto, and, further, replay the vehicle information of the following vehicle subsequent thereto to transfer it to the preceding vehicle.

For example, in the platoon illustrated in FIG. 2, the third vehicle can relay the vehicle information of the first vehicle or the second vehicle to transfer it to the fourth vehicle or the fifth vehicle, and, conversely, can relay the vehicle information of the fourth vehicle or the fifth vehicle to transfer it to the first vehicle or the second vehicle.

In the following description, the selective acquisition of the vehicle information conducted by the communication control portion 210 in the vehicle (the third vehicle) subsequent to at least two or more preceding vehicles (the first vehicle and the second vehicle) will be described in detail.

As illustrated in FIG. 3, the communication control portion 210 can include a received electric power measurement portion 211A and an acquired information selection portion 211B, and selectively acquire the vehicle information based on received electric power (a received signal strength) in the inter-vehicle communication.

The received electric power measurement portion 211A measures the received electric power in the inter-vehicle communication with the preceding vehicle, and outputs information about measured data of the received electric power to the acquired information selection portion 211B.

The acquired information selection portion 211B automatically selects the preceding vehicle to acquire the vehicle information within the range that stabilizes the communication by dynamically switching the vehicle information to acquire based on the measured data of the received electric power.

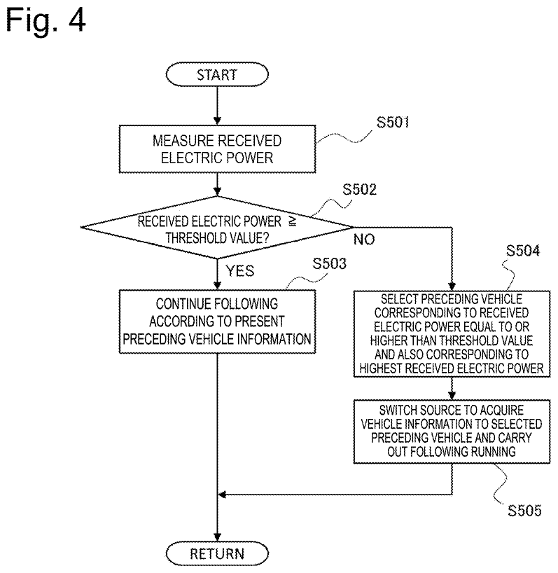

A flowchart illustrated in FIG. 4 indicates a procedure of the processing for selecting the vehicle information that is performed by the communication control portion 210 including the received electric power measurement portion 211A and the acquired information selection portion 211B.

In step S501, the communication control portion 210 measures the received electric power of the vehicle information signal transmitted from the preceding vehicle as needed.

Then, in the next step, step S502, the communication control portion 210 compares the measured data of the received electric power from the preceding vehicle from which the vehicle information is acquired for the following running control at present, with a threshold value.

The threshold value that the communication control portion 210 compares with the measured data of the received electric power is a value based on a lower limit value of the received electric power capable of ensuring the stability of the vehicle communication, and is adapted in such a manner that the communication stability can be ensured if the measured data of the received electric power is equal to or higher than the threshold value, and a possibility of causing communication instability can be estimated if the measured data of the received electric power falls below the threshold value.

If the measured data of the received electric power from the preceding vehicle from which the vehicle information is acquired at present is equal to or higher than the threshold value, the communication control portion 210 proceeds from step S502 to step S503, and continues the following running control while keeping the preceding vehicle to acquire the vehicle information set to the present selection.

In other words, if being in the state that the vehicle information is acquired by inter-vehicle communication in which the received electric power is equal to or higher than the threshold value, the communication control portion 210 keeps the source to acquire the vehicle information set to the present selection without changing it.

On the other hand, if the measured data of the received electric power from the preceding vehicle from which the vehicle information is acquired is lower than the threshold value, the communication control portion 210 proceeds from step S502 to step S504.

In step S504, the communication control portion 210 selects a preceding vehicle corresponding to the measured data of the received electric power equal to or higher than the threshold value and also corresponding to the highest measured data of the received electric power among the other preceding vehicles not including the preceding vehicle targeted for the acquisition of the vehicle information at present, and switches the source to acquire the vehicle information so as to acquire the vehicle information from the selected preceding vehicle.

Then, in the next step, step S505, the communication control portion 210 acquires the vehicle information from the newly selected preceding vehicle and performs the following running control based on the acquired vehicle information.

For example, when the received electric power from the lead vehicle 100 starts to fall below the threshold value with the vehicle running at the third position (the third vehicle) acquiring the vehicle information (the first vehicle information) from the lead vehicle 100 (the first vehicle), the communication control portion 210 of the vehicle running at the third position (a third communication control portion) switches the source to acquire the vehicle information to the vehicle running at the second position (the second vehicle) corresponding to the received electric power equal to or higher than the threshold value, and the vehicle running at the third position performs the following running control based on the vehicle information from the vehicle running at the second position (second vehicle information).

In other words, assuming that the lead vehicle 100 is the first vehicle and the vehicle running at the second position is the second vehicle, the vehicle information processing portion 110 of the lead vehicle 100 corresponds to a first motion state acquisition portion, which acquires the physical amount regarding the motion of the first vehicle, and the communication control portion 120 of the lead vehicle 100 corresponds to a first communication control portion. Further, the vehicle information processing portion 260 of the vehicle running at the second position corresponds to a second motion state acquisition portion, which acquires the physical amount regarding the motion of the second vehicle, and the communication control portion 210 of the vehicle running at the second position corresponds to a second communication control portion.

Further, for example, when the received electric power from the lead vehicle 100 falls below the threshold value with the vehicle running at the fourth position (the fourth vehicle) acquiring the vehicle information from the lead vehicle 100 (the first vehicle), the communication control portion 210 of the vehicle running at the fourth position selects a preceding vehicle (the second vehicle) corresponding to the higher received electric power from the vehicle running at the second position and the vehicle running at the third position as the source to acquire the vehicle information.

In other words, the communication control portion 210 detects and monitors the communication state, and switches the source to acquire the vehicle information to a preceding vehicle corresponding to the received electric power equal to or higher than the threshold value and also corresponding to the highest received electric power and continues the following running control when the received electric power in the communication with the source to acquire the vehicle information in an initial state starts to fall below the threshold value.

The communication control portion 210 can select, for example, a vehicle corresponding to the measured data of the received electric power equal to or higher than the threshold value and also located closer to the head side from the plurality of preceding vehicles as the preceding vehicle to acquire the vehicle information.

Further, the communication control portion 210 can set the standard of the preceding vehicle to acquire the vehicle information to, for example, the lead vehicle 100, and acquire the vehicle information from the lead vehicle 100 while the received electric power from the lead vehicle 100 is higher than the threshold value.

According to this selection processing based on the measured data of the received electric power, even when the received electric power reduces due to some cause, the following vehicle 200 newly selects the preceding vehicle to acquire the vehicle information within the range that stabilizes the communication. Therefore, the present configuration can prevent occurrence of control instability and communication instability due to an increase in the communication delay, a failure in the communication, and the like.

Further, the following vehicle 200 can maintain the acquisition of the vehicle information from the preceding vehicle further ahead of the immediately preceding vehicle within the range that stabilizes the communication. Therefore, the present configuration can prevent accumulation of a delay in the running control compared to when the preceding vehicle repeats the transmission of the vehicle information of this preceding vehicle to the following vehicle immediately subsequent thereto.

Therefore, the present configuration can prevent control instability and communication instability in the following running based on the non-mechanical connection even when the platoon is extended according to an increase in the number of connected vehicles.

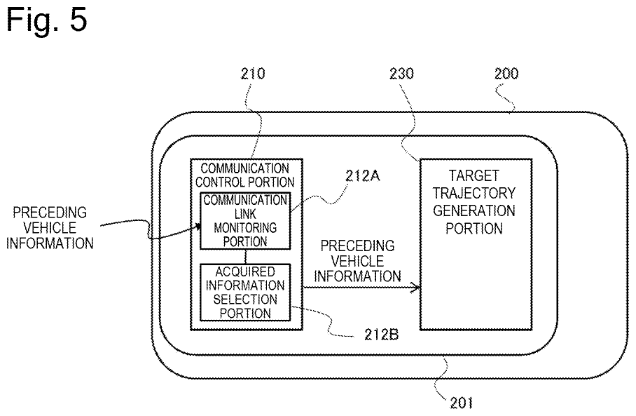

Further or alternatively, the communication control portion 210 can include a communication link monitoring portion 212A and an acquired information selection portion 212B as illustrated in FIG. 5, and selectively acquire the vehicle information based on a result of monitoring the communication link.

The communication link monitoring portion 212A monitors the establishment/disconnection of the communication link as the communication state between the preceding vehicle and this following vehicle 200, and outputs information indicating the monitoring result to the acquired information selection portion 212B.

The acquired information selection portion 212B automatically selects the preceding vehicle to acquire the vehicle information within the range that stabilizes the communication by dynamically switching the vehicle information to acquire based on the establishment/disconnection of the communication link.

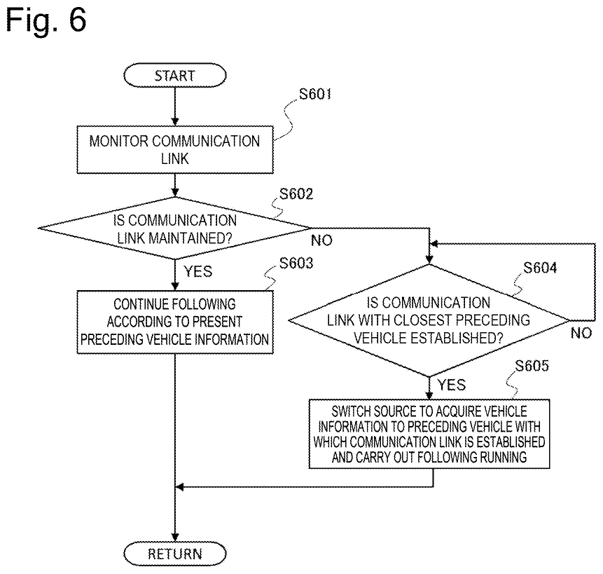

A flowchart illustrated in FIG. 6 indicates a procedure of the processing for selecting the vehicle information that is performed by the communication control portion 210 including the communication link monitoring portion 212A and the acquired information selection portion 212B.

In step S601, the communication control portion 210 monitors the state of the communication link between this following vehicle 200 and the preceding vehicle from which the vehicle information is acquired for the following running control at present, as needed.

Then, in the next step, step S602, the communication control portion 210 determines whether the communication link between this following vehicle 200 and the preceding vehicle from which the vehicle information is acquired at present is kept in an established state or is disconnected.

If the established state of the communication link is maintained, the communication control portion 210 proceeds from step S602 to step S603, and continues the following running control while keeping the preceding vehicle to acquire the vehicle information set to the present selection.

In other words, if the communication link of the inter-vehicle communication is in the established state between this following vehicle 200 and one of the preceding vehicles, the source to acquire the vehicle information does not have to be switched, and the communication control portion 210 continuously acquires the vehicle information via the communication link established at present.

On the other hand, if the communication link between this following vehicle 200 and the preceding vehicle from which the vehicle information is acquired at present is disconnected, the communication control portion 210 proceeds from step S602 to step S604.

In step S604, the communication control portion 210 confirms the establishment of a communication link between this following vehicle 200 and a vehicle located at the shortest distance away from it (corresponding to the closest position in the running order) among preceding vehicles other than the preceding vehicle from which the vehicle information is acquired at present.

Then, upon the establishment of the communication link between this following vehicle 200 and the other preceding vehicle, the communication control portion 210 proceeds to step S605, and acquires the vehicle information from the preceding vehicle with which the communication link is established and performs the following running control based on the acquired vehicle information.

For example, supposing that the communication link between the following vehicle 200 and the lead vehicle 100 is disconnected with the vehicle running at the third position (the third vehicle) acquiring the vehicle information (the first vehicle information) from the lead vehicle 100 (the first vehicle), the communication control portion 210 of the vehicle running at the third position establishes a communication link between it and the immediately preceding vehicle, which is the vehicle running at the second position (the second vehicle), switches the source to the acquire the vehicle information to the immediately preceding vehicle (the second vehicle), and continues the following running control based on the vehicle information from the vehicle running at the second position (the second vehicle information).

On the other hand, for example, supposing that the communication link between the following vehicle 200 and the lead vehicle 100 is disconnected with the vehicle running at the fourth position (the fourth vehicle) acquiring the vehicle information from the lead vehicle 100 (the first vehicle), the communication control portion 210 of the vehicle running at the fourth position establishes a communication link between it and the vehicle running at the third position (the third vehicle), which is the immediately preceding vehicle located at the shortest distance away from it (corresponding to the closest position in the running order), and switches the source to acquire the vehicle information to the immediately preceding vehicle.

In sum, the communication control portion 210 detects and monitors the disconnection/maintenance of the communication link, and, upon a disconnection of the communication link between the following vehicle 200 and the preceding vehicle set as the source to acquire the vehicle information, establishes a communication link with the immediately preceding vehicle, which is highly likely to allow the communication link to be most easily established, and receives the vehicle information, thereby switching the source to acquire the vehicle information.

Therefore, even when the communication link with the preceding vehicle set as the source to acquire the vehicle information may be disconnected, the present configuration allows the following vehicle 200 to switch the source to acquire the vehicle information to a preceding vehicle located at a further short distance away from it and allowing the communication link to be further easily maintained and acquire the vehicle information therefrom, thereby being able to prevent control instability and communication instability in the following running based on the non-mechanical connection even when the platoon is extended according to an increase in the number of connected vehicles.

When detecting that the communication link is disconnected, the communication control portion 210 can establish a communication link with, for example, a preceding vehicle located closer to the head side among preceding vehicles from which the interval distance falls within a set distance and receive the vehicle information therefrom instead of establishing the communication link with the immediately preceding vehicle located at the shortest distance away, and the preceding vehicle with which the communication link is established shall not be limited to the immediately preceding vehicle (the preceding vehicle located at the shortest distance away).

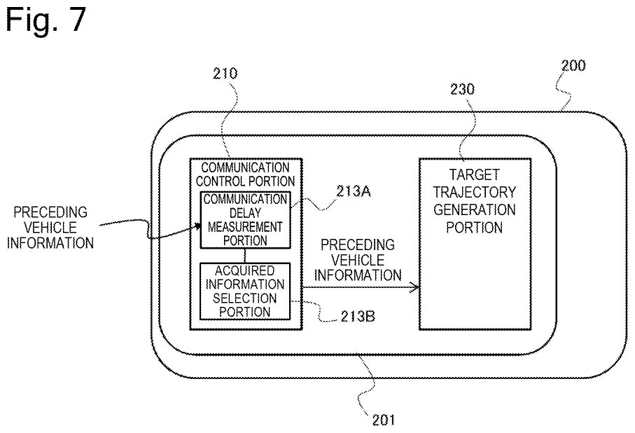

Further or alternatively, the communication control portion 210 can include a communication delay measurement portion 213A and an acquired information selection portion 213B as illustrated in FIG. 7, and selectively acquire the vehicle information based on measured data of a communication delay time.

The communication delay measurement portion 213A measures the communication delay time in the acquisition of the vehicle information from the preceding vehicle as needed, and outputs the measured data of the communication delay time to the acquired information selection portion 213B.

The acquired information selection portion 213B automatically selects the preceding vehicle to acquire the vehicle information within the range that stabilizes the communication by dynamically switching the vehicle information to acquire based on the measured data of the communication delay time.

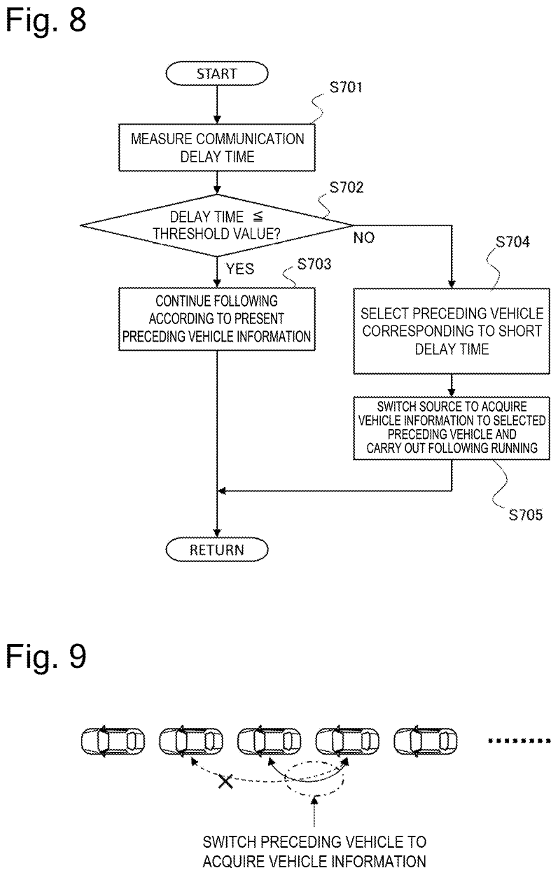

A flowchart illustrated in FIG. 8 indicates a procedure of the processing for selecting the vehicle information that is performed by the communication control portion 210 including the communication delay measurement portion 213A and the acquired information selection portion 213B.

In step S701, the communication control portion 210 measures the communication delay time in the inter-vehicle communication for acquiring the vehicle information as needed.

Then, in the next step, step S702, the communication control portion 210 determines whether the communication delay time in the inter-vehicle communication between this following vehicle 200 and the preceding vehicle from which the vehicle information is acquired at present is equal to or shorter than a threshold value.

The threshold value for the communication delay time is an allowable maximum time or an upper limit time for the communication delay time.

If the communication delay time is equal to or shorter than the threshold value, the communication control portion 210 proceeds from step S702 to step S703, and continues the following running control while keeping the preceding vehicle to acquire the vehicle information set to the present selection.

More specifically, if the communication delay time is equal to or shorter than the threshold value, it can be estimated that the influence of the communication delay is sufficiently small and the control stability can be maintained, and therefore the communication control portion 210 keeps the source to acquire the vehicle information set to the present selection.

On the other hand, if the communication delay time between this following vehicle 200 and the preceding vehicle from which the vehicle information is acquired at present is longer than the threshold value, the communication control portion 210 proceeds from step S702 to step S704.

In step S704, the communication control portion 210 selects a preceding vehicle corresponding to the communication delay time equal to or shorter than the threshold value and also corresponding to the shortest communication delay time among preceding vehicles other than the preceding vehicle from which the vehicle information is acquired at present.

Then, in the next step, step S705, the communication control portion 210 acquires the vehicle information from the preceding vehicle newly selected based on the communication delay time and performs the following control based on the acquired vehicle information.

For example, when the present subject vehicle is the vehicle running at the fourth position from the head and the delay time in the communication between this vehicle and the vehicle running at the second position exceeds the threshold value with this vehicle acquiring the vehicle information via the communication between it and the vehicle (the preceding vehicle) running at the second position, the communication control portion 210 switches the source to acquire the vehicle information to the vehicle running at the third position (the immediately preceding vehicle) if the preceding vehicle corresponding to the communication delay time equal to or shorter than the threshold value and also corresponding to the shortest communication delay time is the vehicle running at the third position.

In other words, the communication control portion 210 detects and monitors the communication delay time in the communication between the vehicles for acquiring the vehicle information of the preceding vehicle, and, when the communication delay time exceeds the threshold value, switches the source to acquire the vehicle information to the preceding vehicle corresponding to the communication delay time equal to or shorter than the threshold value and also corresponding to the shortest communication delay time and performs the following running control.

Therefore, even when the communication delay time may excessively increase between the following vehicle 200 and the preceding vehicle set as the source to acquire the vehicle information, the present configuration allows the following vehicle 200 to switch the source to acquire the vehicle information to a preceding vehicle corresponding to the shorter communication delay time and acquire the vehicle information therefrom, thereby being able to prevent control instability and communication instability in the following running based on the non-mechanical connection even when the platoon is extended according to an increase in the number of connected vehicles.

When detecting that the communication delay time exceeds the threshold value, the communication control portion 210 can select, for example, a preceding vehicle located closer to the head side among preceding vehicles corresponding to the communication delay time equal to or shorter than the threshold value as the source to acquire the vehicle information instead of setting the preceding vehicle corresponding to the shortest communication delay time as the new source to acquire the vehicle information, and the new source to acquire the vehicle information shall not be limited to the preceding vehicle corresponding to the shortest communication delay time.

In this manner, the communication control portion 210 detects and monitors the received electric power, the establishment/disconnection of the communication link, or the communication delay time as the state of the wireless communication for acquiring the vehicle information. Then, when some trouble occurs in the communication route (a failure in the communication device, a radio disturbance, or the like) to impair the communication state to cause any of a reduction in the received electric power, a disconnection of the communication link, and an increase in the communication delay time, the communication control portion 210 switches the source to acquire the vehicle information to a preceding vehicle in a communication state that allows the vehicle information to be further stably acquired to acquire the vehicle information therefrom and continues the following running control.

FIG. 9 illustrates how the preceding vehicle to acquire the vehicle information is switched.

In the case of FIG. 9, the vehicle running at the fourth position from the head of the platoon corresponds to the subject vehicle, and initially acquires the vehicle information by communicating with the vehicle running at the second position among the preceding vehicles.

Then, supposing that a trouble occurs in the communication route between the subject vehicle and the vehicle running at the second position to cause a reduction in the received electric power, a disconnection of the communication link, an increase in the communication delay time, or the like, the subject vehicle selects, for example, the immediately preceding vehicle, which is the vehicle running at the third position, as the source to acquire the vehicle information as the communication partner that makes it possible to avoid these problems, and switches the source to acquire the vehicle information from the vehicle running at the second position to the vehicle running at the third position and continues the following running control, thereby maintaining the platoon running.

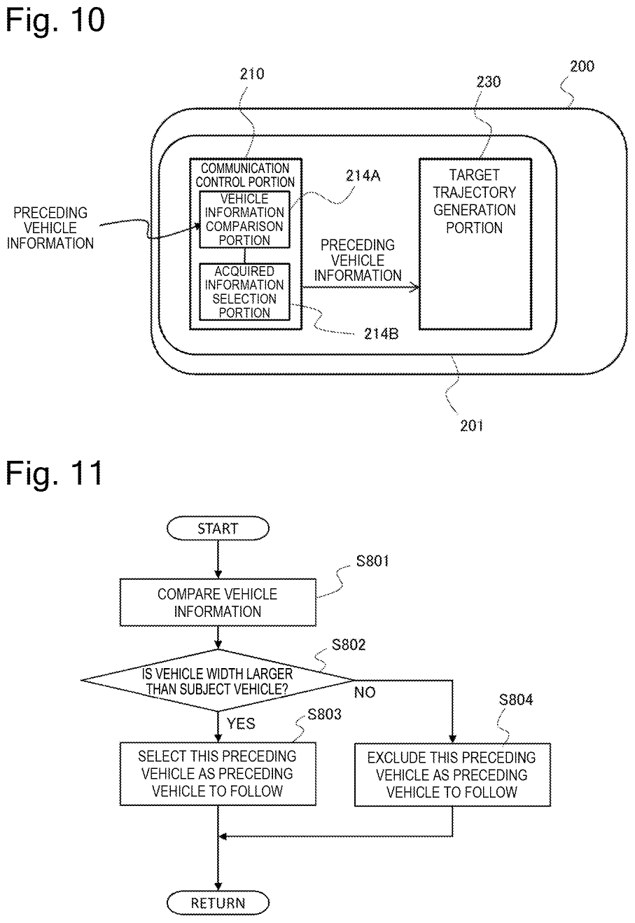

The above-described communication control portion 210 acquires the vehicle information regarding the preceding vehicle while selecting it based on the state of the communication with the preceding vehicle, but the communication control portion 210 can include a vehicle information comparison portion 214A and an acquired information selection portion 214B as illustrated in FIG. 10 and selectively acquire the vehicle information based on a result of a comparison between the vehicle information of the preceding vehicle and the vehicle information of the subject vehicle.

Now, the vehicle information comparison portion 214A compares, for example, a motion performance such as the acceleration/deceleration characteristic and/or the dimension of the vehicle body between the preceding vehicle and the subject vehicle, and outputs the result of the comparison to the acquired information selection portion 214B.

The acquired information selection portion 214B automatically selects the preceding vehicle to acquire the vehicle information (the vehicle that the subject vehicle follows) within the range capable of maintaining stable platoon running by dynamically switching the vehicle information to acquire based on the result of the comparison between the vehicle information of the preceding vehicle and the vehicle information of the subject vehicle.

For example, the acquired information selection portion 214B can prevent the following subject vehicle from failing to pass through on a road (the running trajectory) although the preceding vehicle has been able to pass through on this road, by selecting a preceding vehicle larger in vehicle width than the subject vehicle.

Further or alternatively, the acquired information selection portion 214B can prevent the subject vehicle from failing to follow the acceleration/deceleration of the preceding vehicle and thus increasing or reducing the distance between the subject vehicle and the preceding vehicle, by causing the subject vehicle to follow the preceding vehicle having a motion performance such as the acceleration/deceleration characteristic that is equivalent to or lower than the subject vehicle.

A flowchart illustrated in FIG. 11 indicates a procedure of the processing for selecting the vehicle information that is performed by the communication control portion 210 including the vehicle information comparison portion 214A and the acquired information selection portion 214B.

In step S801, the communication control portion 210 compares the vehicle information acquired from the preceding vehicle and the vehicle information of the subject vehicle.

The vehicle information compared by the communication control portion 210 in step S801 is, for example, the dimension of the vehicle body and/or the engine performance, which are the vehicle specification information, and the communication control portion 210 compares the vehicle specification information transmitted from the preceding vehicle as the vehicle information and the vehicle specification information of the subject vehicle that is held by the vehicle information processing portion 260.

Next, in step S802, the communication control portion 210 determines whether the vehicle specification information of the preceding vehicle satisfies a predetermined eligibility as the preceding vehicle to follow based on the vehicle specification information of the subject vehicle.

Then, if the vehicle specification information of the preceding vehicle satisfies the eligibility, the communication control portion 210 proceeds to step S803 and selects this preceding vehicle as the preceding vehicle to follow.

On the other hand, if the vehicle specification information of the preceding vehicle does not satisfy the eligibility, the communication control portion 210 proceeds to step S804 and excludes this preceding vehicle as the preceding vehicle to follow.

For example, the communication control portion 210 selects a preceding vehicle having a vehicle width (a full width) equal to or wider than the subject vehicle as the preceding vehicle to follow, and/or selects a preceding vehicle having an acceleration/deceleration performance equivalent to or lower than the acceleration/deceleration performance of the subject vehicle as the preceding vehicle to follow.

In sum, the communication control portion 210 determines that a preceding vehicle having a vehicle width equal to or wider than the vehicle width of the subject vehicle and/or having an acceleration/deceleration performance equivalent to or lower than the acceleration/deceleration performance of the subject vehicle has the eligibility as the preceding vehicle to follow, and determines that a preceding vehicle having a vehicle width narrower than the vehicle width of the subject vehicle and/or having an acceleration/deceleration performance higher than the acceleration/deceleration performance of the subject vehicle does not have the eligibility as the preceding vehicle to follow.

In other words, the preceding vehicle to follow (the preceding vehicle from which the vehicle information used in the following control is received) is preset in the communication control portion 210 based on the vehicle specification information such as the vehicle width and the acceleration/deceleration performance.

For example, when comparing the vehicle width, the communication control portion 210 presets a preceding vehicle having a vehicle width equal to or wider than the vehicle width of the subject vehicle as the preceding vehicle to follow, and selects a preceding vehicle having a vehicle width equal to or wider than the vehicle width of the subject vehicle as the preceding vehicle having the eligibility as the target to follow while excluding a preceding vehicle having a vehicle width narrower than the vehicle width of the subject vehicle as the preceding vehicle to follow, and selectively receives the vehicle information from the preceding vehicle having the eligibility as the target to follow.

Then, the communication control portion 210 starts the platoon running if the preceding vehicle according to the running order determined before the platoon running is started has the eligibility, and, for example, outputs a signal requesting a rearrangement of the running order or refrains from participating in the platoon running if the preceding vehicle lacks the eligibility.

If the preceding vehicle to follow has a vehicle width equal to or wider than the subject vehicle, the subject vehicle can also pass through on a road where the preceding vehicle has passed through, which means that this preceding vehicle has the eligibility as the target to follow. Further or alternatively, if the preceding vehicle to follow has an acceleration/deceleration performance equivalent to or lower than the subject vehicle, the subject vehicle can be prevented from failing to keep up with the acceleration of the preceding vehicle and thus causing an increase in the distance between the vehicles or failing to keep up with the deceleration of the preceding vehicle and thus causing a reduction in the distance between the vehicles.

The vehicle specification information used to select the preceding vehicle to follow is not limited to the vehicle width and the acceleration/deceleration performance, and the communication control portion 210 can perform the processing for selecting the preceding vehicle to follow based on vehicle specification information such as the vehicle height (the full height), the minimum ground clearance, the tread, and the minimum turning radius.

The communication control portion 210 allows the subject vehicle to also pass through on a road where the preceding vehicle has passed through by selecting a preceding vehicle having a vehicle height equal to or taller than the subject vehicle as the preceding vehicle to follow in the case of the selection processing based on the height of the vehicle, and selecting a preceding vehicle having a minimum ground clearance equal to or shorter than the subject vehicle as the preceding vehicle to follow in the case of the selection processing based on the minimum ground clearance.

Further or alternatively, in the case of the selection processing based on the tread or the minimum turning radius, the acquired information selection portion 214B can prevent the platoon from being disordered due to, for example, outward swelling of the running trajectory of the subject vehicle beyond the preceding vehicle while running a curve, by selecting a preceding vehicle having a tread or a minimum turning radius equal to or greater than the subject vehicle as the preceding vehicle to follow.

The acquired information selection portions 211B to 214B can be provided outside the communication control portion 210.

Each technical idea described in the above-described embodiments can be used in combination as appropriate within a range not creating a contradiction.

Having described the contents of the present invention specifically with reference to the preferred embodiments thereof, it is apparent to those skilled in the art that the present invention can be embodied by various modifications based on the basic technical idea and teaching of the present invention.

The communication control portion 210 can switch the source to acquire the vehicle information by combining a plurality of items among the received electric power, the establishment/disconnection of the communication link, and the communication delay time as the state of the wireless communication.

For example, the communication control portion 210 can select a preceding vehicle corresponding to the highest received electric power or a preceding vehicle corresponding to the shortest communication delay time as the new source to acquire the vehicle information among preceding vehicles with which a communication link can be established when the communication link is disconnected.

Alternatively, the communication control portion 210 can detect and monitor the received electric power and the communication delay time, and select the source to acquire the vehicle information among preceding vehicles corresponding to received electric power equal to or higher than a threshold value and also corresponding to a communication delay time equal to or shorter than a threshold value.

Then, technical ideas recognizable from the above-described embodiments will be described in the following description.

A vehicle control apparatus, as one configuration thereof, acquires preceding vehicle information including information regarding a control operation amount and a running state amount of a preceding vehicle via wireless communication between vehicles forming a platoon, and controls following running based on a non-mechanical connection based on the acquired preceding vehicle information. The vehicle control apparatus switches a source to acquire the preceding vehicle information according to a state of the wireless communication.

According to a preferable configuration of the vehicle control apparatus, the state of the wireless communication includes at least one of received electric power, establishment/disconnection of a communication link, and a communication delay time.

Further, a vehicle control apparatus, as one configuration thereof, acquires preceding vehicle information including information regarding a motion of a preceding vehicle via wireless communication between vehicles forming a platoon, and controls following running based on a non-mechanical connection based on the acquired preceding vehicle information. The preceding vehicle information includes specification information of the preceding vehicle. The vehicle control apparatus selects a preceding vehicle to follow based on a comparison between specification information of a vehicle on which this vehicle control apparatus is mounted and the specification information of the preceding vehicle.

According to a preferable configuration of the vehicle control apparatus, the specification information includes at least one of information regarding a motion performance of the preceding vehicle and information regarding a dimension of a vehicle body of the preceding vehicle.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2018-223105 filed on Nov. 29, 2018. The entire disclosure of Japanese Patent Application No. 2018-223105 filed on Nov. 29, 2018 including the specification, the claims, the drawings, and the abstract is incorporated herein by reference in its entirety.

### REFERENCE SIGNS LIST

100 lead vehicle
110 vehicle information processing portion
111 driver
112 accelerator pedal
113 brake pedal
114 steering wheel
120 communication control portion
130 vehicle control apparatus
200 following vehicle
201 vehicle control apparatus
210 communication control portion
220 preceding vehicle recognition portion
230 target trajectory generation portion
240 vehicle motion control portion
250 actuator control portion
260 vehicle information processing portion

1. A vehicle control apparatus mounted on a third vehicle in a vehicle following running system in which a first vehicle, a second vehicle subsequent to the first vehicle, and the third vehicle subsequent to the second vehicle carry out following running by being non-mechanically connected,
the vehicle control apparatus being configured to
selectively acquire first vehicle information including a first physical amount regarding a motion of the first vehicle and second vehicle information including a second physical amount regarding a motion of the second vehicle,
determine a third physical amount regarding a motion of the third vehicle based on the vehicle information acquired selectively from the first vehicle information and the second vehicle information, and
output an instruction based on the determined third physical amount to a braking/driving apparatus and a steering apparatus of the third vehicle.

2. The vehicle control apparatus according to claim 1, wherein the vehicle control apparatus selectively receives one of the first vehicle information and the second vehicle information.

3. The vehicle control apparatus according to claim 2, wherein the vehicle control apparatus switches which is received, the first vehicle information or the second vehicle information, according to a predetermined condition.

4. The vehicle control apparatus according to claim 3, wherein the predetermined condition includes received electric power in communication of the vehicle information between the vehicles.

5. The vehicle control apparatus according to claim 3, wherein the predetermined condition includes a disconnection or establishment of a communication link in communication of the vehicle information between the vehicles.

6. The vehicle control apparatus according to claim 3, wherein the predetermined condition includes a delay time in communication of the vehicle information between the vehicles.

7. The vehicle control apparatus according to claim 2, wherein the selectively received vehicle information is preset.

8. The vehicle control apparatus according to claim 7, wherein the vehicle control apparatus selects the vehicle information to receive based on a comparison with vehicle information of the third vehicle.

9. The vehicle control apparatus according to claim 1, wherein the vehicle control apparatus determines the third physical amount by selectively using one of the first vehicle information and the second vehicle information.

10. The vehicle control apparatus according to claim 1, wherein the vehicle control apparatus transfers at least one of the acquired first vehicle information and second vehicle information to a subsequent fourth vehicle.

11. A vehicle control method configured to be performed by a third vehicle in a vehicle following running system in which a first vehicle, a second vehicle subsequent to the first vehicle, and the third vehicle subsequent to the second vehicle carry out following running by being non-mechanically connected, the vehicle control method comprising:
selectively acquiring first vehicle information including a first physical amount regarding a motion of the first vehicle and second vehicle information including a second physical amount regarding a motion of the second vehicle;
determining a third physical amount regarding a motion of the third vehicle based on the vehicle information acquired selectively from the first vehicle information and the second vehicle information; and
outputting an instruction for achieving the determined third physical amount to a braking/driving apparatus and a steering apparatus of the third vehicle.

12. A vehicle following running system comprising:
a first vehicle;
a second vehicle subsequent to the first vehicle; and
a third vehicle subsequent to the second vehicle,
the first vehicle, the second vehicle, and the third vehicle being configured to carry out following running by being non-mechanically connected,
the first vehicle including
a first vehicle motion state acquisition portion configured to acquire a first physical amount regarding a motion of this first vehicle, and
a first communication control portion configured to transmit first vehicle information including the first physical amount,
the second vehicle including
a second vehicle motion state acquisition portion configured to acquire a second physical amount regarding a motion of this second vehicle, and
a second communication control portion configured to transmit second vehicle information including the second physical amount,
the third vehicle including
a third communication control portion configured to be able to acquire the first vehicle information and the second vehicle information, and
a control unit configured to
selectively receive the first vehicle information and the second vehicle information,
determine a third physical amount regarding a motion of the third vehicle based on the vehicle information acquired selectively from the first vehicle information and the second vehicle information, and
output an instruction based on the determined third physical amount to a braking/driving apparatus and a steering apparatus of the third vehicle.
